(19) United States
(12) Patent Application Publication
(10) Pub. No.: US 2020/0084623 A1
(43) Pub. Date: Mar. 12, 2020

(54) CONTROLLING OPERATION OF A MOBILE DEVICE BASED ON USER IDENTIFICATION

(71) Applicant: International Business Machines Corporation, Armonk, NY (US)

(72) Inventors: Wisam Mohammed, Raleigh, NC (US); Glenn Reschke, Apex, NC (US); Christopher Florence, Raleigh, NC (US)

(21) Appl. No.: 16/122,911

(22) Filed: Sep. 6, 2018

(51) Int. Cl. H04W 12/06; G06K 9/00; H04L 29/06

(52) U.S. Cl. CPC H04W 12/06; G06K 9/00288; G06F 3/043; H04L 63/102; G06K 9/0002; H04L 63/0861

(57) ABSTRACT

Methods, systems and computer program products for controlling an operation of a mobile device based on user identification are provided. Aspects include receiving, by the mobile device, a request to perform a requested action and obtaining, in response to the request, an identification of one or more individuals that are looking at a display screen of the mobile device. Aspects also include obtaining a security profile for the mobile device and performing the requested action based on a determination that the security profile indicates that the one or more individuals are authorized to view a result of the requested action.

### BACKGROUND

The present invention relates generally to controlling a mobile device, and more specifically, to controlling operation of a mobile device based on user identification.

As mobile devices continue to become more powerful and include additional functionality, these devices can contain more and more personal information, including photos, accounts of various apps and all kinds of payment information. The increase of personal, often sensitive data on mobile devices, can lead to users not allowing others access to their mobile device. For example, often a user wishes to show another person a photo on their mobile device but does not want to allow the other person access to other data stored on the mobile device, i.e., they do not want the other person to be able to view other pictures on their mobile device.

### SUMMARY

An embodiment of a computer-implemented method for controlling operation of a mobile device based on user identification is provided. The method includes receiving, by the mobile device, a request to perform a requested action and obtaining, in response to the request, an identification of one or more individuals that are looking at a display screen of the mobile device. The method also includes obtaining a security profile for the mobile device and performing the requested action based on a determination that the security profile indicates that the one or more individuals are authorized to view a result of the requested action.

An embodiment of a mobile device that operates at least in part based on user identification is provided. The mobile device includes a processor configured to perform receiving, by the mobile device, a request to perform a requested action and obtaining, in response to the request, an identification of one or more individuals that are looking at a display screen of the mobile device. The processor is further configured to perform obtaining a security profile for the mobile device and performing the requested action based on a determination that the security profile indicates that the one or more individuals are authorized to view a result of the requested action.

An embodiment of a computer program product for performing a processing action includes a computer readable storage medium having program instructions embodied therewith, the program instructions readable by a processing circuit to cause the processing circuit to perform a method. The method includes receiving, by the mobile device, a request to perform a requested action and obtaining, in response to the request, an identification of one or more individuals that are looking at a display screen of the mobile device. The method also includes obtaining a security profile for the mobile device and performing the requested action based on a determination that the security profile indicates that the one or more individuals are authorized to view a result of the requested action.

### BRIEF DESCRIPTION OF THE DRAWINGS

The subject matter which is regarded as embodiments is particularly pointed out and distinctly claimed in the claims at the conclusion of the specification. The foregoing and other features, and advantages of the embodiments are apparent from the following detailed description taken in conjunction with the accompanying drawings in which:

FIG. 1 depicts a block diagram of a mobile device in accordance with an embodiment;

FIG. 2 depicts a flow diagram of a method for controlling operation of a mobile device based on user identification in accordance with an embodiment; and

FIG. 3 depicts a flow diagram of another method for controlling operation of a mobile device based on user identification in accordance with an embodiment.

### DETAILED DESCRIPTION

Apparatuses, systems, and methods are provided controlling the operation of a mobile device based on user identification. In one embodiment, a mobile device, such as a smartphone, is configured to only perform actions that result in sensitive information being displayed on a screen of the mobile device when only authorized individuals are looking at the screen of the mobile device. In one example, upon receiving a request to perform an action that would result in the display of sensitive information, the mobile device determines what individuals are looking at the screen of a mobile device. The identity of the individuals is compared to a security profile and the mobile device can responsively perform the requested action, perform a related action, or can deny the request altogether.

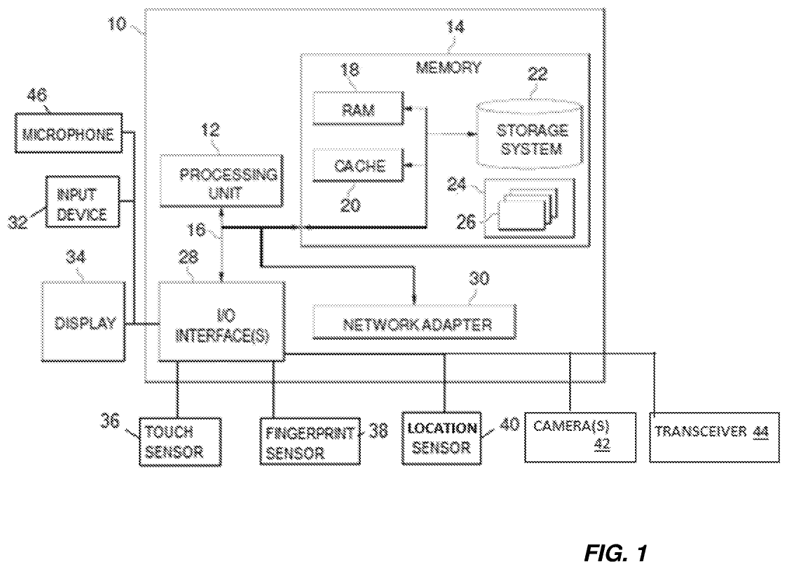

Referring now to FIG. 1, an example of a mobile device 10 that can be used to perform various actions, including receiving and processing user inputs and performing various processing actions as described herein, including storing and processing data, executing programs and displaying information is shown. The mobile device 10 may be configured to receive or gather communications (e.g., data, text, spoken words, emails, authentication information, etc.) from other locations, such as a network (e.g., Internet) and/or another processor (e.g., server, computer or mobile device). The mobile device 10 may be any device capable of receiving user input, performing processing actions and displaying text and other information to a user, such as a mobile device (e.g., a smartphone), a wearable device (e.g., a smartwatch and/or fitness tracker), a tablet computer, a laptop computer, a desktop computer, a mainframe a server and others.

The mobile device 10 includes various components and/or modules for performing various processing, sensing and display functions. The mobile device 10 includes one or more processors or processing units 12, a memory 14, and a bus 16 that couples various components including the memory 14 to the processor 12.

The memory 14 includes computer readable media in the form of volatile memory, such as random access memory (RAM) 18 and/or cache memory 20. The mobile device 10 may also include other removable/non-removable, volatile/non-volatile computer system storage media. For example, the memory 14 includes storage 22 including a non-removable, non-volatile magnetic media (e.g., a hard drive), and/or removable storage media such as a memory card or flash drive. The memory 14 may include at least one program product having a set (e.g., at least one) of program modules that are configured to carry out the functions of embodiments described herein. For example, the memory 14 stores a program or utility suite 24 including one or more program modules 26 to carry out the functions and/or methodologies of embodiments described herein.

The mobile device 10 includes or is connected to various components, which may be incorporated in the mobile device 10 or external to the mobile device 10. The mobile device 10 includes interfaces 28 for communication with components and may also include a network adapter 30 for communication with other devices or components over a suitable network or remote connection. The mobile device 10 is connected to or includes at least one input device 32 such as a keyboard, button, mouse and/or touchscreen, and a display 34. In one embodiment, the mobile device 10 also includes a location sensor 40 can be used for determining the location of the mobile device 10. The components shown in FIG. 1 and described herein are provided for illustrative purposes and are not intended to be limiting.

The mobile device 10 also includes a touch sensor 36 that is configured to detect contact and/or pressure from a user, e.g., via one or more fingers and/or other input devices such as styluses. The touch sensor 36 detects not only finger position, but also movements along a touchscreen. Movements of a finger or finger used an input to the mobile device 10 are referred to herein as movements, motions or swipes. In this way, the touch sensor 36 may be used by the mobile device 10, e.g., in conjunction with other input devices and program modules 26, to recognize an input performed by a user. Any suitable type of touch sensor 36 may be included in the device. For example, the touch sensor 36 is a capacitive or acoustic wave sensor. The touch sensor 36 may be located under a touchscreen or embedded within the touchscreen (e.g., between screen layers).

As described herein, an input refers to any interaction between a user and a touchscreen or other input device. An input may be a touch at some location on the touchscreen by an object (e.g., one or more fingers), a movement or swipe of the touching object or a combination thereof. The movement may include an extent (e.g., the distance along a path of the touch), speed and/or path of the movement along the touchscreen. Other aspects of an input may include, for example, an amount of pressure, a number of touches (e.g., single “click” or double-click), and any other criteria that may be used to discern the nature of the input and differentiate it relative to other inputs.

The mobile device 10 also includes a biometric finger pattern sensor 38 that is configured to detect characteristics of the user's fingers, such as a fingerprint, portion of a fingerprint, or another characteristic that allows, e.g., identification of a user and/or differentiation between the individual fingers of a user. Such characteristics, whether utilized individually or in combination, are referred to herein as “finger patterns.” A “finger pattern” refers to any detectable feature or features, or any other identifying information detected by the finger pattern sensor that can be used to identify characteristics of individual fingers of a user's hand and/or differentiate between fingers. An example of a fingerprint pattern sensor is a capacitive sensor. The finger pattern sensor 38, in one example, is embedded in or below a touchscreen or a portion of a touchscreen.

The mobile device 10 also includes one or more cameras 42. The cameras 42 include a front facing camera that is configured to capture images that include individuals that are looking at the display 34 of the mobile device 10. The processing unit 12 of the mobile device 10 is configured to perform facial recognition on the images captured by the camera 42 to identify one or more known individuals and to detect the presence of any unknown individual that are looking at the display 34 of the mobile device 10. The memory 14 of the mobile device 10 includes stored images of known individuals and a security profile that are used by the mobile device to determine whether to perform requested actions.

In exemplary embodiments, the mobile device 10 includes a plurality of security profiles that are used to control the operation of the mobile device 10 based on the identification of individuals that are looking at the display 34 of the mobile device 10. In one example, a first security profile corresponds to when only the owner, or primary user, of the mobile device 10 is looking at the display 34 of the mobile device 10. Accordingly, the first security profile allows full access to the functionality of the mobile device 10. In another example, a second security profile corresponds to when only a known user other than the primary user of the mobile device 10 is looking at the display 34 of the mobile device 10, such as a spouse or a child of the primary user. In this case, the second security profile allows access to some of the functionality of the mobile device 10 but restricts access to specified applications and notification. In another example, a third security profile corresponds to when an unknown user is looking at the display 34 of the mobile device 10. In this case, the third security profile allows access to only a selected subset of the functionality of the mobile device 10 but restricts access to most applications and notification. For example, the third security profile may only allow access to a phone application and a web-browsing application.

The mobile device 10 also includes a transceiver 44 that is configured to directly communicate with one or more electronic devices via any known protocol, such a Bluetooth. The one or more electronic devices can include a speaker or headset, a smartwatch, a television, a computer, an automobile, or the like. The mobile device 10 also includes a microphone 46 or other sound recording device may be included for recording voice commands and recording changes in voice or other audible indicators. The processing unit 12 of the mobile device 10 is configured to perform voice recognition on audio captured by the microphone 46 to identify one or more known individuals. The memory 14 of the mobile device 10 includes stored samples of known voices and a security profile that are used by the mobile device to determine whether to perform requested actions.

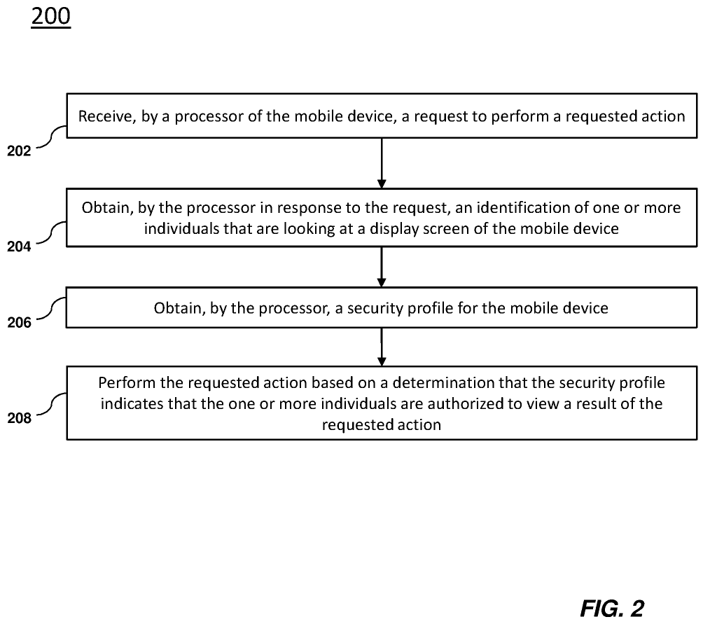

Referring now to FIG. 2 an embodiment of a method 200 for controlling operation of a mobile device based on user identification is shown. As illustrated at block 202, the method 200 includes receiving, by a processor of the mobile device, a request to perform a requested action. In one embodiment, the request is received from a user of the mobile device. In another embodiment, the request is received from an application executing on the mobile device. Next, as shown at block 204, the method 200 includes obtaining, by the processor in response to the request, an identification of one or more individuals that are looking at a display screen of the mobile device. In exemplary embodiments, obtaining the identification of one or more individuals that are looking at the display screen of the mobile device includes capturing an image with a front facing camera of the mobile device and performing facial recognition on the image.

The method 200 also includes obtaining, by the processor, a security profile for the mobile device, as shown at block 206. The security profile includes facial identification information for authorized users, a set of permissions for each authorized user and for unknown users. In exemplary embodiments, the method 200 includes comparing the identified faces in the image captured by the mobile device with one or more stored facial images in the security profile. Next, as shown at block 208, the method 200 includes performing the requested action based on a determination that the security profile indicates that the one or more individuals are authorized to view a result of the requested action.

In one embodiment, the request is a request to display applications installed on the mobile device. For example, the request can include the user clicking on a portion of the display that requests that the mobile device display a list of applications installed on the mobile. In exemplary embodiments, the security profile includes one or more categories of applications, such as public applications and restricted applications. The public applications include applications that can be seen and/or used by unknown users, such applications include a web browser application, a camera application, and the phone application. The restricted applications include applications that can only be seen and/or used by authorized users, such applications include banking applications, messaging applications and the like. In exemplary embodiments, in response to receiving a request to display applications installed on the mobile device, the mobile device determines if any unknown individuals are looking at the display screen and if so, the mobile device displays a subset of the applications installed on the mobile device (i.e., the public applications). However, if the individuals looking at the display screen are known, the mobile device displays the applications that the individuals are authorized to see. In exemplary embodiments, the security profile can include many different categories of applications that can be used to control which individuals can see/use each application.

In one embodiment, the request is a request to display a notification on the display from an application installed on the mobile device. For example, the request can be received from a messaging application and can be a request to display an incoming message on the display screen of the mobile device. In exemplary embodiments, in response to receiving a request to display a notification from an application installed on the mobile device, the mobile device determines if any unknown individuals are looking at the display screen and, if so, the mobile device will either display a notification, but not the message, or take no action. However, if the individuals looking at the display screen are known and authorized to see the message, the mobile device displays the message on the display screen of the mobile device.

In one embodiment, the request can be a request that is received from a user during the execution of an active application such as a photo viewing application. For example, if the request is a swipe left or right that indicates a desire to view a different photograph in a photo or image viewing application. The determination of whether to grant perform the requested action is based on what individuals are viewing the display of the mobile device and the security profile.

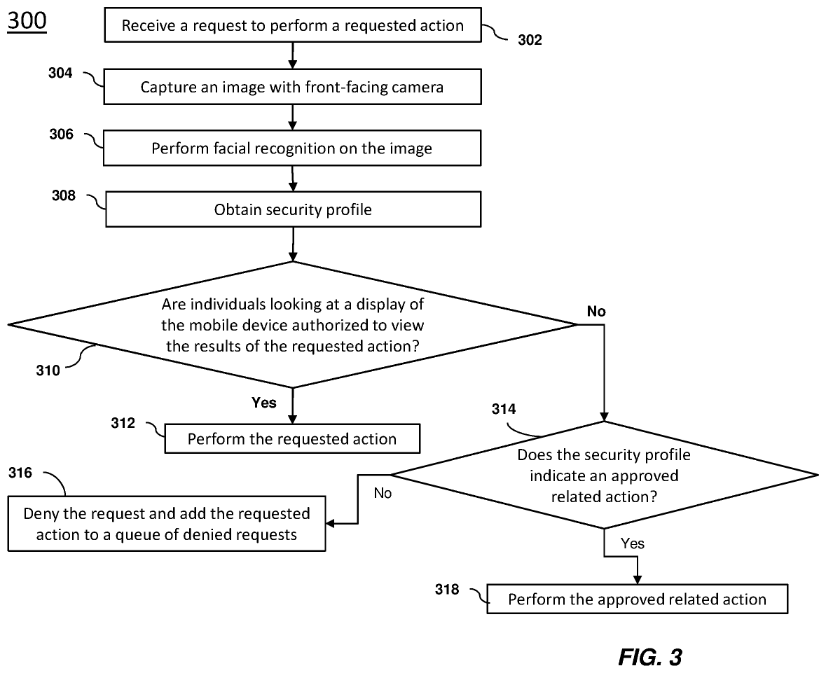

FIG. 3 illustrates an embodiment of a method for controlling operation of a mobile device based on user identification. As illustrated at block 302, the method 300 includes receiving a request to perform a requested action, as shown at block 302. Next, as shown at block 304, the method 300 includes capturing an image with a front-facing camera of the mobile device. The method 300 then performs facial recognition on the captured image, as shown at block 306, and obtains a security profile, as shown at block 308.

Continuing with reference to FIG. 3, as shown at decision block 310, the method 300 determines whether any individuals looking at the display of the mobile device are authorized to view the results of the requested action. If the individuals looking at the display of the mobile device are authorized to view the results of the requested action, the method 300 proceeds to block 312 and performs the requested action. If the individuals looking at the display of the mobile device are not authorized to view the results of the requested action, the method 300 proceeds to decision block 314 and determines whether the security profile indicate an approved related action.

In one embodiment, an approved related action is an action that is similar to the requested action but which will return or display a different result. For example, a requested action may be to display the content of a received text message and an identity of the source of the message and the approved related action may be to only display an indication of an incoming text message which may or may not include the source of the message but which does not include the content of the text message. In another example, a requested action may be to display all of the applications installed on a mobile device and the approved related action may be to only display a subset of the installed applications based on the individuals looking at the display screen. If the security profile includes an approved related action, the method 300 proceeds to block 318 and performs the approved related action. Otherwise, the method 300 proceeds to block 316 and denies the requested action and adds the requested action to a queue of denied requests.

In one embodiment, the queue of denied requests can be accessed by an authorized user of the mobile device and one or more of the denied requests can be automatically performed by the mobile device based on a determination that the authorized user is the only user looking at the display screen. For example, if during a period of time while an unknown user one or more text messages were received by the mobile device but the notification of them was blocked by the security profile. When the mobile device determines that only the authorized user is the only user looking at the display screen, notifications for these text messages can automatically be displayed.

Technical effects and benefits include the ability for a mobile device to achieve a greater level of privacy for the user by preventing the display sensitive content when non-authorized users are looking at the display of the mobile device.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application and to enable others of ordinary skill in the art to understand the invention for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of controlling an operation of a mobile device based on user identification, the method comprising:
receiving, by a processor of the mobile device, a request to perform a requested action, wherein the request is a request to display applications installed on the mobile device and wherein the request is received from an application executing on the mobile device;
obtaining, by the processor in response to the request, an identification of one or more individuals that are looking at a display screen of the mobile device;
obtaining, by the processor, a security profile for the mobile device;
performing the requested action based on a determination that the security profile indicates that the one or more individuals are authorized to view a result of the requested action; and
based on a determination that the security profile indicates that the one or more individuals are not authorized to view all of the applications installed on the mobile device, displaying only a subset of the applications installed on the mobile device, wherein the subset is determined based upon the security profile.

2. The method of claim 1, wherein obtaining the identification of one or more individuals that are looking at the display screen of the mobile device includes:
capturing an image with a front facing camera of the mobile device; and
performing facial recognition on the image.

3. The method of claim 1, wherein the security profile includes facial identification information for authorized users, a set of permissions for each authorized user and for unknown users.

4. (canceled)

5. (canceled)

6. (canceled)

7. (canceled)

8. The method of claim 1, wherein the request is a request to display a notification from the application.

9. A mobile device for performing a processing action, the mobile device comprising:
a sensor configured to receive an input from a user; and
a processor configured to perform:
receiving a request to perform a requested action, wherein the request is a request to display applications installed on the mobile device and wherein the request is received from an application executing on the mobile device;
obtaining, in response to the request, an identification of one or more individuals that are looking at a display screen of the mobile device;
obtaining a security profile for the mobile device;
performing the requested action based on a determination that the security profile indicates that the one or more individuals are authorized to view a result of the requested action; and
based on a determination that the security profile indicates that the one or more individuals are not authorized to view all of the applications installed on the mobile device, displaying only a subset of the applications installed on the mobile device, wherein the subset is determined based upon the security profile.

10. The mobile device of claim 9, wherein obtaining the identification of one or more individuals that are looking at the display screen of the mobile device includes:
capturing an image with a front facing camera of the mobile device; and
performing facial recognition on the image.

11. The mobile device of claim 9, wherein the security profile includes facial identification information for authorized users, a set of permissions for each authorized user and for unknown users.

12. (canceled)

13. (canceled)

14. (canceled)

15. (canceled)

16. The mobile device of claim 9, wherein the request is a request to display a notification from the application.

17. A computer program product for performing a processing action, the computer program product comprising:
a computer readable storage medium having program instructions embodied therewith, wherein the computer readable storage medium is not a signal, the program instructions readable by a processing circuit to cause the processing circuit to perform a method comprising:
receiving, by a processor of a mobile device, a request to perform a requested action, wherein the request is a request to display applications installed on the mobile device and wherein the request is received from an application executing on the mobile device;
obtaining, by the processor in response to the request, an identification of one or more individuals that are looking at a display screen of the mobile device;
obtaining, by the processor, a security profile for the mobile device; and
performing the requested action based on a determination that the security profile indicates that the one or more individuals are authorized to view a result of the requested action; and
based on a determination that the security profile indicates that the one or more individuals are not authorized to view all of the applications installed on the mobile device, displaying only a subset of the applications installed on the mobile device, wherein the subset is determined based upon the security profile.

18. The computer program product of claim 17, wherein obtaining the identification of one or more individuals that are looking at the display screen of the mobile device includes:
capturing an image with a front facing camera of the mobile device; and
performing facial recognition on the image.

19. (canceled)

20. (canceled)
